(19) United States
(12) Patent Application Publication
(10) Pub. No.: US 2003/0229648 A1
(43) Pub. Date: Dec. 11, 2003

(54) Integrating dynamic, context-sensitive awareness into software applications

(76) Inventors: John C. Tang, Palo Alto, CA (US); Nicole Y. Mordecai, Weston, MA (US); Donald Gentner, Palo Alto, CA (US); James M.A. Begole, Mountain View, CA (US); Michael L. Van De Vanter, Mountain View, CA (US)

Correspondence Address: Thelen Reid & Priest, LLP, P. O. Box 640640, San Jose, CA, 95164-0640, US

(21) Appl. No.: 10/167,870

(22) Filed: Jun. 11, 2002

(51) Int. Cl. G06F 7/00

(52) U.S. Cl. 707/104.1

(57) ABSTRACT

The present invention provides a method and apparatus for integrating dynamic, context-sensitive awareness into software applications. In one embodiment, a computer interface is provided that helps users identify and interact with advisors having a particular expertise or interest. The list of advisors is dynamically created, based on an activity that the user os performing. In one embodiment, a list of advisors meeting defined criteria are identified and optionally ranked according to the level of expertise or knowledge the person has, in relation to the specified criteria.

### BACKGROUND

1. Field of the Invention

This invention relates to the field of computer software, and in particular to a method and apparatus for integrating dynamic, context-sensitive awareness into software applications.

2. Background Art

Sometimes computer users wish to contact other computer users in regard to some subject related to the context of their present use of the computer. For example, in some instances computer users need help when using a software feature, when debugging programming code they have written, etc. In other instances, computer users may need advice before purchasing a book, video or stock. To receive assistance, the user must be able to contact others having the proper expertise or experience, in order to be able to discuss the issue and receive the desired feedback.

A built-in help function is often accessed by selecting a menu function within the software program and typically provides of a list of topics that the software provider believes will be useful to the user. Invoking the help function while the user is using certain features of a software program may trigger the help function to display topics related to those features.

Although built-in help functions are often useful for their intended purpose, the categories of information provided are often too broad, and the provided information cannot be tailored to the particular needs of particular users at a given time.

Another type of assistance, on-line help, is available on the internet that typically consists of interaction with technical support staff through a text-based means such as a chat screen where a question may be asked by a user, and then answered by a help advisor. Personal interaction through conversation has numerous benefits, such as an advisor can adjust his or her assistance according to a user's level of proficiency. In some prior art systems, the user is able to view the advisor's display on the user's computer and/or the advisor is able to view the user's display on the advisor's computer. This enables the advisor to see exactly what the user is doing. It also allows the user to view a demonstration by the advisor of a solution to the problem.

One of the biggest disadvantages of on-line help systems is that it is often very difficult for users to locate an advisor that can quickly and efficiently provide the desired information.

### SUMMARY OF THE INVENTION

The present invention provides a method and apparatus for integrating dynamic, context-sensitive awareness into software applications. In one embodiment, a computer interface is provided that helps users identify and interact with advisors having a particular expertise or interest. In one embodiment, a list of advisors meeting defined criteria are identified and optionally ranked according to the level of expertise or knowledge the person has, in relation to the specified criteria.

In one embodiment, a list of selectable advisors is provided within a software program. Particular advisors may be included or excluded from the list, based on either of user-definable or predefined criteria. Such criteria may include the level of familiarity an advisor has with a particular subject matter area, the availability of the advisor, the level of cost associated with the desired advice from particular advisors, and other criteria. By selecting an advisor on the list, a user may optionally do any of the following: determine when the advisor is available for consultation, determine any charges associated with the consultation, initiate communication with the advisor, or perform other actions associated with receiving the services an advisor may offer.

In another embodiment, computer activities associated with application software and/or operating system actions are monitored and a list of advisors who are familier with identical or similar activities is provided. Optionally, advisors may be added to or deleted from the list regardless of the level of familiarity the advisor has with the subject matter area.

### BRIEF DESCRIPTION OF THE DRAWINGS

These and other features, aspects and advantages of the present invention will become better understood with regard to the following description, appended claims and accompanying drawings where:

FIG. 1 illustrates one embodiment network of computers capable of practicing the present invention.

FIG. 2 is a flowchart depicting one embodiment of the present invention using the network of FIG. 1.

FIG. 3 depicts a pull-down menu in accordance with one embodiment of the present invention.

### DETAILED DESCRIPTION OF THE INVENTION

In this specification, reference is made to “advisors”. It is intended that this term refer generally to individuals, groups of individuals, website addresses (Uniform Resource Locators, hereinafter termed “URL's”) where advice may be obtained, and business entities regardless of the context in which the term appears.

The term “list” as used herein includes single item compilations as well as multiple item compilations. Thus, a “list of advisors” might just have a single item “Steve Johnson” (a ficticious person used for example purposes only), or a single item “Davidson Consulting” (a fictitious business consulting group used for example purposes only), or alternatively may include multiple items of differing character such as a list containing both “Steve Johnson” (an individual), “Davidson Consulting” (a business entity), and “www.consulting.com/chat”, a Uniform Resource Locator representing an internet site configured to provide real-time interactive chat sessions.

One aspect of the present invention is directed to a user interface that is configured to provide an interface including a list of advisors meeting user-definable criteria. The list may be sorted according to the relevence of the advisor to predefined criteria. Optionally, the existence of one or more advisors on the list may be determined by comparing attributes associated with the advisor with attributes specified by a user. Optionally, the interface may be configured to include information about advisors appearing on the list. Further, the interface is optionally configured to initiate and manage an interactive communication session with one or more advisors on the list. Optionally, the activities being performed on the users' computer are tracked, and a list of advisors who have subject matter expertise in the activities being performed may be prepared, based on these activities and the expertise of those users in performing identical or similar tasks.

The present invention is preferably performed in a computing environment having at least three computer systems occasionally or perpetually coupled together, forming a network. In an exemplery embodiment, an environment practicing the present invention includes four computer systems.

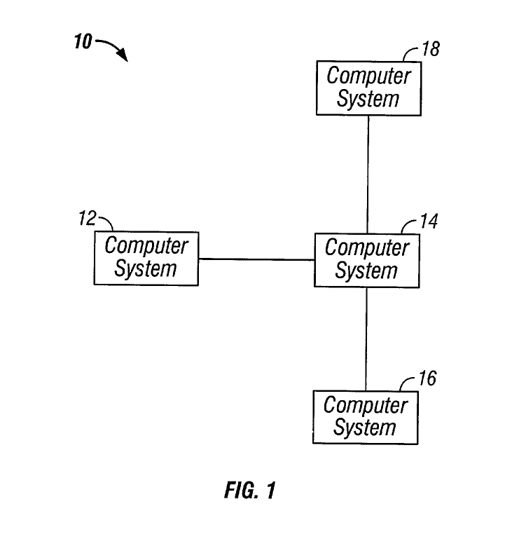

FIG. 1 illustrates one embodiment network of computers capable of practicing the present invention.

Referring to FIG. 1, network 10 is presented including coupled computer systems 12, 14, 16, and 18. Although this example network includes four computer systems, those of ordinary skill in the art familiar with this disclosure will readily appreciate that the present invention may be practiced in networks having many more computers linked together.

One example configuration of network 10 useful for practicing the present invention includes client systems 12, 16, and 18 coupled to server 14. Server 14 may be optionally configured as an application server to provide and execute software applications of various types for client systems 12, 16, and 18. In this configuration, one or more software applications may be configured to practice the present invention in whole or in part.

Illustrating the use of the present invention, client computer 12 has a user performing a computer activity and who needs support. This desired support may take the form of receiving help in performing a particular specialized action, receiving advice as to which product has superior features as compared to other products, receiving programming advice, and the like. Those of ordinary skill in the art will appreciate that many more possible uses of the present invention are possible. In this example, one or more advisors are available at one or more client systems such as client systems 16 and 18. In order for the present invention to help a user, at least one of the advisors is familiar with the desired support area.

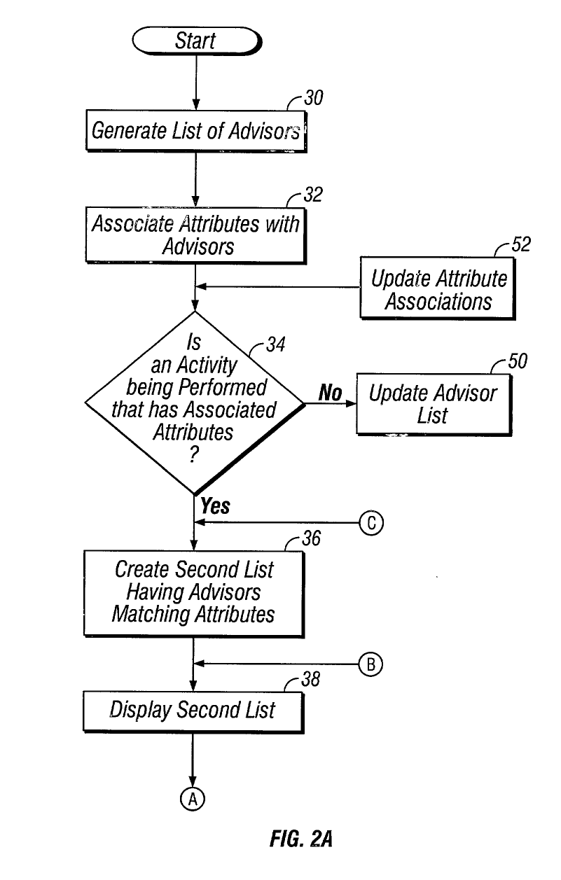

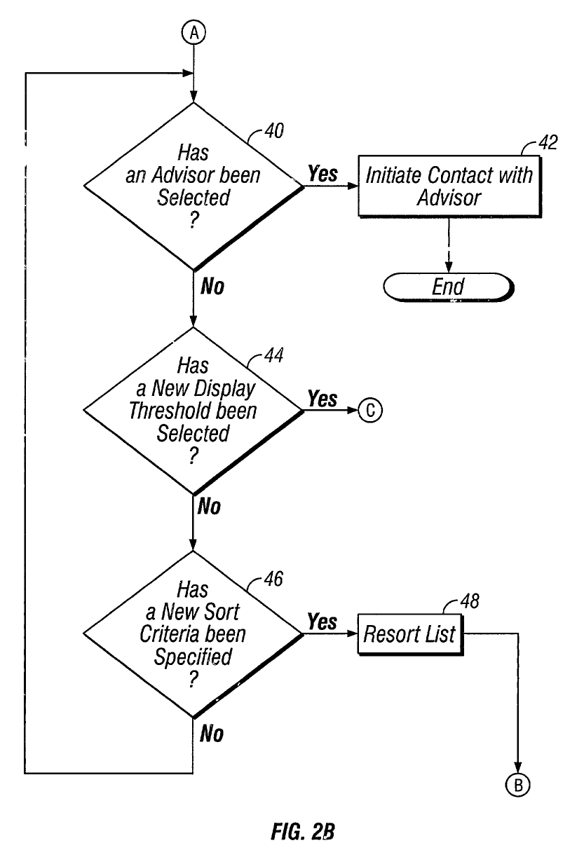

FIG. 2 is a flowchart depicting one embodiment of the present invention using the network of FIG. 1.

Referring to FIG. 2, at block 30, a list of advisors is generated. This list may optionally include any of one or more of advisors currently available at client computers on the network, advisors occasionally available at client computers on the network, and advisors available off the network for which required information is available to the network.

At block 32 attributes are associated with the advisors on the list generated at block 30. Such attributes optionally include any of the following: the subject matter areas the advisor is familiar with, times the advisor is available, the methods by which the advisor may be contacted, the cost associated with using the advisor, if any, etc. By way of example, if an advisor has used a given application for many hours, and has performed certain identifiable tasks using that application, attributes relating to that period of usage of the given application would be cataloged and associated with that advisor. Another example includes advisors having performed particular kinds of searches, made particular kinds of purchases, edited and/or compiled computer code, etc. Other attributes will be ascertainable by those of ordinary skill in the art familiar with this disclosure and the subject matter intended to be served by particular implementations of the present invention.

At block 34 it is determined whether there is an activity being performed by a user that has associated attributes. If yes, the method proceeds at block 36 where it is determined which advisors have attributes similar to the activity attributes identified at block 34. At this point, a second list of those advisors is prepared.

In one embodiment, advisors having at least one attribute matching an activity attribute will be listed on the second list.

In another embodiment, a display threshold may be selected by the user that determines how many advisor attributes must match the activity attributes prior to placing a given advisor on the second list.

In yet a third embodiment, a preselected display threshold is provided upon which a rendering of the second list may be based. For example, a user may decide to list all experts having a single attribute matching the current or recent user activity. Alternatively, the user may choose a particular attribute that is especially important to match. If a geographical locale is especially important, the user may decide to limit the second list to experts at certain locations. It is contemplated that combinations of these examples may also be made available as selectable criteria for determining the advisors on the second list. If a user decides to change the display threshold, the list will be modified to incorporate the new threshold.

At block 38, the second list is displayed for the user. In practice, the display of the second list may be triggered by many different possible events. For example, the display may be triggered when the user selects a “help” menu within a piece of software they are working with. Alternatively, the display may be triggered by the user searching through the various menus, possibly indicating that the user is unfamiliar with how to perform a desired task. Those of ordinary skill in the art will readily appreciate that many other methods for triggering a display to occur may be implemented without departing from the scope or purpose of the present invention.

It is contemplated by the inventors that “user preferences” would be consulted when either developing or displaying the second list to determine such details as the current display threshold and the desired sorting criteria. Some users might prefer to sort the second list in a particular way. By way of example, if the second list includes advisors previously labeled by the user as having given good advice, being “trusted”, being personally known to the user, etc., a user may decide to have those particular advisors sorted to the top of the second list. Those of ordinary skill familiar with this disclosure will be able to develop a method for determining users' preferences while remaining within the scope and purpose of the present invention.

At block 40, it is determined whether an advisor has been selected from the second list. If yes, the method proceeds at block 42 where contact with the advisor is initiated. It is contemplated by the inventors that contact may be initiated by opening a communication path between an online advisor and the user and communicating via text, voice or other means over that path. Alternatively, if an advisor is not available for real-time communication, contact may be initiated through other means, such as electronic mail, voice mail, and the like. All of such communication, whether or not in real-time, will be referred to herein as interactive communication.

If at block 40 it is determined that an advisor has not yet been selected from the second list, the method proceeds at block 44 where it is determined whether the optional display threshold has been changed since the last time the second list was prepared. If yes, the method proceeds again at block 36. It is contemplated that implementations of the present inventions may not include a display threshold, or may include a fixed display threshold. Alternatively, if block 44 mathodology is present in an implementation, it is contemplated that the display threshold will be either user selectable or dynamic.

One example dynamic implementation contemplated by the inventor includes consideration of the length second list. For example, if there are ten advisors that meet specified criteria, and the maximum length of the display space for the second list includes space for four advisors, the display threshold might be dynamically set to ensure that only four advisors are listed in the second list. Alternatively, the second list could include all ten advisors, but only four would be displayed at a time, with the remaining advisors being displayed through a scrolling window or other mechanism known to those of ordinary skill.

In practice, suppose a user is performing a spreadsheet task such as writing a macro. In this instance, that task might have attributes such as “programming task” and “text editing”. From a list if advisors known to the network, a second list of advisors having attributes related to programming tasks and/or text editing would be generated. Optionally, at block 40, this second list would be displayed for the user, as a result of user. indicating the desire to receive help. In an alternate embodiment, block 34 would not take place until the user had indicated a desire to review the list of advisors.

In one embodiment, the displayed list would include one or more of the following: the name of the advisor, the times the advisor is available, the cost of receiving services from the advisor, and the like.

If, at block 44, a new display threshold has not been selected, the method proceeds at block 46 where it is determined whether a new sort criteria has been selected. If yes, the method proceeds at block 48 where the second list is resorted using the new criteria. If no, the method proceeds again at block 40.

If, at block 34 there isn't an activity being performed that has associated attributes, the method optionally proceeds at block 50 where the first list is updated to reflect any new data that may have been developed since the last version of the list was prepared.

At block 52, changes to attribute associations required as a result of advisor changes on the first list are accomplished.

As previously stated, in one embodiment of the present invention, an application server configured to host software applications may also be configured to practice the present invention. It is contemplated by the inventors that the operating system and application software would interoperate to track the activities of users of the server, including the applications they utilize to perform tasks.

In one embodiment, application software is optionally configured to provide the operating system information about which tasks each user performs, including information such as how long each task is performed, skills required to perform the task to completion, etc. The operating system is optionally configured to provide the application software details about the advisors available to the system, the attributes associated with each advisor, and any other information to be presented in a list of advisors. Those of ordinary skill will readily appreciate that although the application software and the operation system must interoperate in order for maximum efficiency to be obtained when practicing the present invention, various aspects of the invention may be present in either.

In another embodiment, the application software manages the presentation of the advisor data to the user, and may manage initiation of communication with one or more selected advisors. In yet another embodiment of the present invention, the operating system manages the presentation of data to the user and may manage initiation of communication with one or more selected advisors.

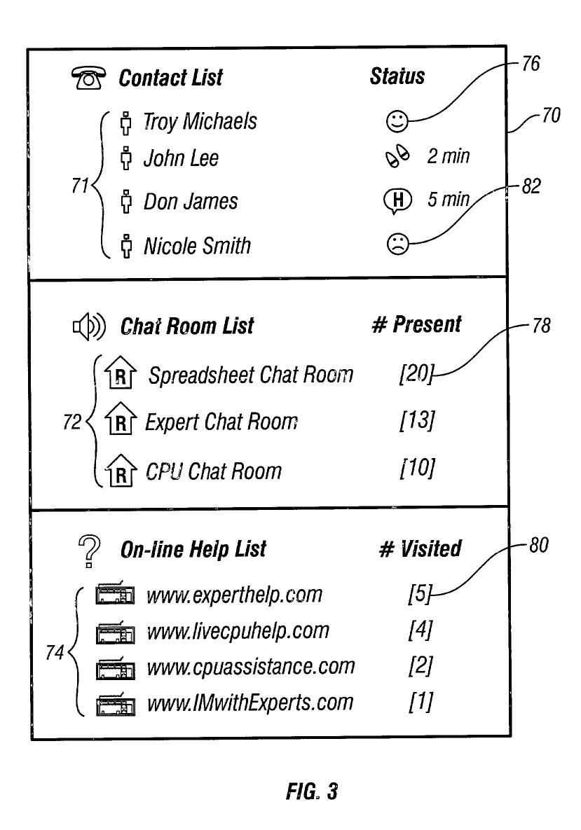

FIG. 3 depicts a pull-down menu in accordance with one embodiment of the present invention.

Referring to FIG. 3, list 70 includes groups 71, 72, and 74 of advisors. Associated with each advisor is an optional indicator 76, 78, 80, and the like that indicates either the status of the respective advisor or other information such as how many times the user has communicated with this advisor or, in the case of a community help room (such as a chat room, seen as item 78) the number of users present in the chat room. Sophisticated systems are contemplated that are configured to determine how many advisors matching attributes are present at a given time in a chat room. In these sophisticated systems, indicator 78 may optionally be configured to list the number of advisors in the chat room that match selectable criteria.

In one embodiment of the present invention the status information associated with advisors is updated automatically within a reasonable time after such status changes are recognized by the server.

Once a decision has been made to contact an advisor, the user typically selects the advisor using their keyboard or mouse, thus initiating communication to the advisor. It is contemplated that the communication type will be related to the status of the advisor as indicated to the system. Thus, if the status information indicates that the advisor is immediately available (such as might be indicated by indicator 76, for example), a real-time communication might be attempted. Alternatively, if the status information indicates that the advisor is away from the computer (such as might be indicated by indicator 82), an email communication, voice mail communication or some other form of offline communication might be initiated.

1. A method for establishing communication between a computer user performing a computer activity and an advisor comprising:
providing a first list of advisors, each advisor having at least one attribute;
ranking each advisor based on the relevance of at least one of said advisor attribute to said computer activity;
creating, by determing which advisors on said first list that are ranked higher than a ranking threshold, a second list of advisors.

2 The method of claim 1 further including
causing at least one advisor from said second list to be selected for communication; and
initiating communication with at least one of said selected advisors.

3. The method of claim 1 further including
manually selecting at least one advisor from said first list to be added to said second list.

4. The method of claim 1 wherein said ranking threshold is predetermined.

5. The method of claim 1 wherein said ranking threshold is determined by said computer user.

6. The method of claim 1 wherein said attributes include at least one of the following: the number of times the advisor has performed the activity, the amount of time the advisor has performed the activity, information relating to the availability of the advisor for consultation, the cost of consultation, activities the advisor has performed in the past, methods by which the advisor may be contacted.

7. The method of claim 1 further including
adding at least one advisor to said second list that doesn't meet said ranking criteria.

8. The method of claim 1 further including
displaying said second list;

9. The method of claim 1 further including
sorting said second list based on the results of said ranking;

10. The method of claim 1 wherein said second list is automatically updated as the activity being performed by said computer user changes.

11. The method of claim 1 wherein said activity includes a programming task.

12. The method of claim 11 wherein said programming task includes editing computer code.

13. The method of claim 11 wherein said programming task includes compiling computer code.

14. The method of claim 1 wherein said activity includes performing a search.

15. The method of claim 1 wherein said activity includes purchasing an item from a vendor.

16. The method of claim 1 wherein said activity includes searching for an item to purchase.

17. The method of claim 16 wherein said item is a book, and said attributes include one of the following: whether an advisor has read the book, whether an advisor has purchased the book, whether the advisor is familiar with the book.

18. The method of claim 1 wherein said activity includes reviewing information about a movie, and wherein said attributes include one of the following: a list of movies the advisor has seen, whether an advisor is familiar with said movie.
